(19) United States
(12) Patent Application Publication
(10) Pub. No.: US 2014/0114692 A1
(43) Pub. Date: Apr. 24, 2014

(54) System for Integrating First Responder and Insurance Information

(71) Applicant: InnovaPad, LP, Greenville, SC (US)

(72) Inventor: Vikram Pearce, Greenville, SC (US)

(21) Appl. No.: 14/058,476

(22) Filed: Oct. 21, 2013

Related U.S. Application Data
(60) Provisional application No. 61/717,464, filed on Oct. 23, 2012.
(60) Provisional application No. 61/816,936, filed on Apr. 29, 2013.

(51) Int. Cl. G06Q 40/08; G06Q 50/26

(52) U.S. Cl. CPC G06Q 40/08; G06Q 50/265
USPC 705/4

(57) ABSTRACT

A system for automating and integrated incident reported with cost recovery comprising: a server having a computer readable medium, processor and in electronic communications with a remote computing device, national fire database, state database of incidents, insurance companies, judicial system, police departments and fire departments; and, a set of server computer readable instructions stored in the server computer readable medium that, when executed by the processor, perform steps of: receiving incident report data from the remote computer device, receiving insurance information from an insurance provider, generating insurance claims, generating at least one incident report according to a predetermined format and the incident data and the insurance data, receiving report approval information from a supervisor, finalizing the incident report, transmitting the incident report to at least one member of a group comprising: national fire reporting system, state incident reporting system, first responding system, judicial system, insurance system, service providers system and individual involved with the incident, generating an insurance claim, transmitting the insurance claim to at least one insurance company, receiving insurance claim status information, providing the insurance claim status information to the first responder(s) involved with the incident.

### CROSS-REFERENCE TO RELATED APPLICATIONS

The present application claims priority under 35 U.S.C. §119 to U.S. Provisional Patent Application Ser. No. 61/717,464, filed Oct. 23, 2012 and to U.S. Provisional Patent Application No. 61/816,936, filed Apr. 29, 2013, the entire content of each of which is incorporated herein by reference as if set forth in its entirety herein.

### FIELD OF THE INVENTION

This invention is directed to a system for integrating information generated and used by emergency medical services and first responders with the insurance claims processing for individuals and municipalities.

### BACKGROUND

There is a trend for emergency medical service (EMS) organizations and first responders to charge for the services provided; services traditionally provided at taxpayers' expense. For example, New York City's fire department recently announced that it would be charging motorists a fee for responding to traffic accidents. The decisions to charge for these services is driven partially by EMS and first responders to seek new revenue streams with declining budgets. Further, charging for services distributed the costs to those involved with the incident, regardless of whether those involved are taxpayers for that particular EMS or first responder organization. These “accident response fees” are designed to provide additional revenue to communities without raising property or personal income taxes.

However, there have been disappointing results with these programs due to improper implementation and underlying technology. For example, one city in New York reports that it realized $14,000 in 2011 rather than the estimated $100,000 it expected. Another city in California realized $40,000, an amount significantly under the expected $200,000. Further, the first responders (including EMS), particularly fire departments, were claiming that more time was required at accident scenes for collecting information needed to make insurance claims which removed these organizations from service for other emergencies.

In some cases, the recipient of the bill from the municipality has insurance that potentially will reimburse the recipient for all or part of the charge. However, currently the systems used by first responders or EMS organizations require time and resources from the EMS or first responder to provide the needed information above and beyond completing an accident report or incident report. In response, third party companies have formed to generate claims, handle the insurance adjustment, implement collection procedures and other administrative activities. These third parties are one step removed from the information contained on the official incident report and in many cases require the EMS or first responder to enter information a second time after the incident report is completed.

U.S. Pat. No. 8,121,753 is directed to a system and associated method for gathering and submitting data to a third party in response to a vehicle being involved in an accident. First an information manager stores data regardless of the vehicle being involved in an accident. Next the event detection manager stores data in response to detecting the vehicle being involved in an accident. Next the information manager stores state data pertaining to the vehicle's current state. Then an adjacent identifier manager requests, receives and stores data from surrounding vehicles in memory. Next a report is generated and encrypted. Finally, the encryption and transmission manager stores the report in memory. However, this invention is limited to sensor data being attached to a vehicle and reporting on the physical circumstances of the accident itself.

United States Patent Application 2009/0106139 discloses a cost recovery billing system for a responder department includes a first computer based device having cost recovery billing software operably disposed thereon for purposes of billing a responsible party for an at fault incident. The system electronically receives responsible party incident report data from a responder, searches the responsible party incident report data for cost determinative data, manipulates the cost determinative data to provide cost data and associates the cost data with insurance claim data in order to produce bill data for presentation to an insurance provider. However, this application is limited in that the cost recovery system is initiated with the actual call from the bill recipient to the responder.

There have been some attempts to automate the accident reporting process itself such as with United States Patent Application 2010/0161491 which is directed to a “computer implemented method for rapidly and securely filing, via wireless means, a consolidated accident report”. This application provides for an electronic accident report that can be completed by both (or multiple) parties to an accident at the accident location. The report can then be transmitted to the appropriate interested party.

Further, United States Patent Application 2012/0078662 discloses a device, system, and method for digitally filling out, completing, and transmitting an emergency medical services report form. The computerized emergency medical services report form is designed to mimic the emergency medical services report form that the user is already accustomed to completing during an incident. The user completes the digital form by entering the incident data into the form via a touch screen or keyboard. Because the digital form is essentially identical to the paper form, the users do not require a significant amount of additional training on how to fill out the digital form. However, this application seems to be directed to providing information to a medical facility after the EMS has completed its portion of the infield treatment and the injured party is transferred to a medical facility.

Therefore, it is an object of the current invention to provide for a system and method for obtaining information from an event such as an accident from the first responder or reporting databases, generating an insurance claim, generating accident reports according to predetermined report formats, transmitting such accident reports to the appropriate receiving agencies, including, but not limited to police, fire, and judicial systems, managing insurance claims processing, and billing and charges.

### SUMMARY

The above objectives are accomplished by providing a system for automating and integrated accident report with cost recovery comprising: a server having a computer readable medium, processor and in electronic communications with a remote computing device, national fire database, state database of accidents, insurance companies, judicial system, police departments and fire departments; and, a set of server computer readable instructions stored in the server computer readable medium that, when executed by the processor, perform steps of: receiving accident report data from the remote computer device or reporting device, receiving insurance information from an insurance provider, generating an insurance claims, generating at least one accident report according to a predetermined format and the accident data and the insurance data, receiving report approval information from a supervisor, finalizing the accident report, transmitting the accident report to at least one member of a group comprising: national fire reporting system, state accident reporting system, first responding system, judicial system, insurance system, service providers system and individual involved with the accident, generating an insurance claim, transmitting the insurance claim to at least one insurance company, receiving insurance claim status information, providing the insurance claim status information to the first responder(s) involved with the accident.

### DESCRIPTION OF THE DRAWINGS

The following description of the invention will be better understood by reference to the following drawings that are incorporated and made part of the written specification:

FIG. 1 is schematic of the invention illustrating data and process flow of aspects of the invention;

FIG. 2 is schematic of the invention illustrating data and process flow of aspects of the invention;

FIG. 3 is schematic of the invention illustrating data and process flow of aspects of the invention;

FIG. 4 is schematic of the invention illustrating data and process flow of aspects of the invention; and,

FIG. 5 is schematic of the invention illustrating data and process flow of aspects Of the invention.

### DETAILED DESCRIPTION

Computer readable instructions, when executed by a computer processor, cause the computer to perform a series of steps to accomplish a specific task and results in useful, concrete and tangible results. This computer readable code is tied to a particular machine or apparatus with specific purpose of executing the computer readable code for accomplishing tangible results, and represents and accomplishes the manipulation of physical data.

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result when executed by a computer and its processor representing or resulting in the tangible manipulation of physical objects. These steps also require physical manipulations of physical quantities such as electrical or magnetic physical elements and are capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code.

Elements of the flowchart support combinations of means for performing the special functions, combination of steps for performing the specified functions and program instruction means for performing the specified functions. It will be understood that each block of the flowchart illustrations can be implemented by special purpose hardware-based computer systems that perform the specified functions, steps, or combinations of special purpose hardware or computer instructions.

The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

The present invention seeks to provide first responders (including, but not limited to police, fire, EMS etc.) an automated mobile tool to reduce clerical work and increase their efficiency while providing new sources of revenue for municipalities. The present invention can use a smart phone, iPad, iPhone or other portable computing device to allow accident data to be gathered electronically and recorded more easily, while letting users be mobile and outside the vehicle whenever needed. Accident information from the first responder agencies (including but not limited to police, fire EMS, etc.) can be integrated to recover the cost of fire department traffic accident cleanup. By transmitting information digitally to/from insurance, police, fire, federal, court computers, transactions are faster and more accurate, and manual data re-entry is reduced.

Besides the application for mobile accident data collection and integration, these portable computing devices and the present invention will also allow for the interface with existing legacy systems such as through terminal emulation. Fixed character/keyboard PC terminals in first responder vehicles can even be replaced with the remote computer of the present invention.

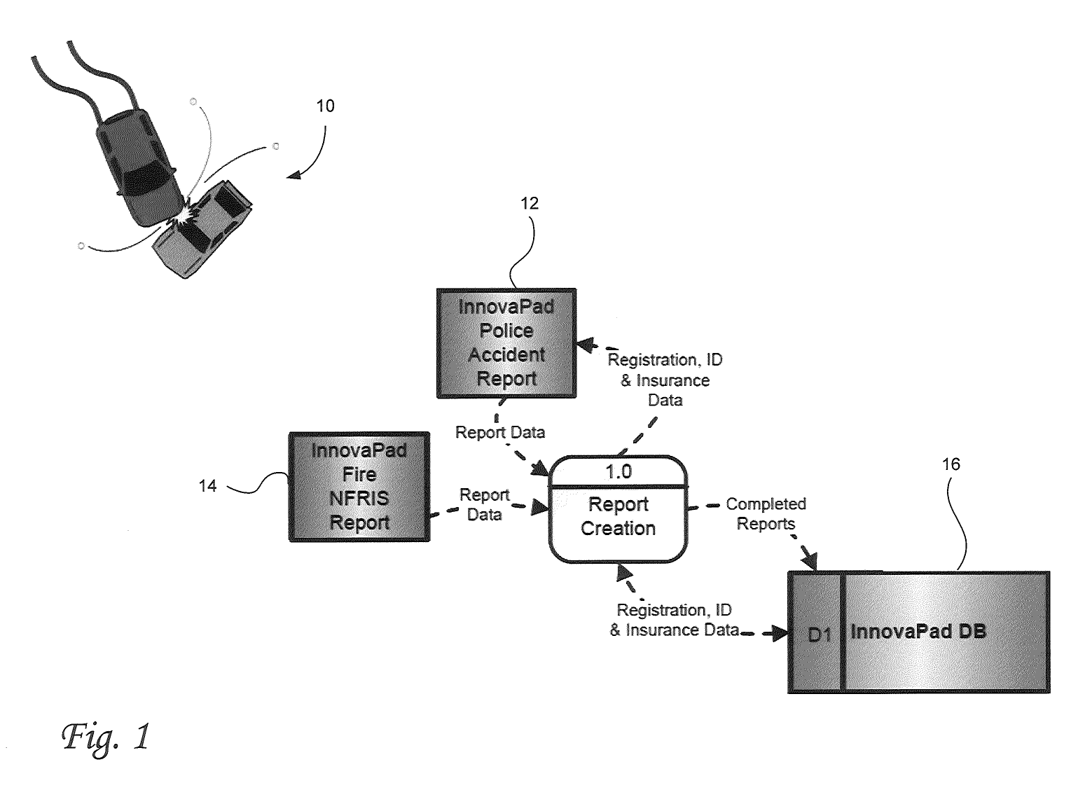

Referring to FIG. 1, an incident, for example a car accident, occurs as shown at 10. In response, there can be responders that are called to the scene which can include fire department, EMS (typically a part of the fire department) or police. Once arriving on the scene, the responders perform various services including extractions, medical care, accident clean-up, hazardous material handling and clean-up, and other various services. In many municipalities, police reports and fire reports are required to document the scene, the actions taken, and the individuals and property involved. Currently, the police report is a standardized report, but varies from state to state and even department to department. For example, the highway patrol may use a different report form than a sheriff. In other jurisdictions, the report is standardized statewide. In any event, the reports are typically in paper format and regulated by state laws.

Further, the fire departments also have report forms to complete and these reports, typically, have to comply with the national requirements of the National Fire Incident Reporting System promulgated by the Department of Homeland Security, Federal Emergency Management Agency and the U.S. Fire Administration. Disadvantageously, the police and fire system are not integrated and have no common reports format, structure or system. Therefore, the present invention includes remote computer readable instructions on a remote computer readable medium that when executed by a processor of the remote computer device performs the functionality described herein. The present invention provides a user interface that can be installed on a smart phone, tablet, portable computer or the like allowing the responder to complete the information at the accident scene. The information such as physical location information, date, time, GPS information, vehicle information, equipment information, incident response time information, inventory allocation information, incident response actions taken information, incident recovery time information, structure information, property damage information, injury information, insurance information, personally indentifying information, audio information, video information, image information, responder information, weather information, local information, development information, passenger/driver information, speed information, legal violation information, text and graphical information can be included in the digital report form. Moreover, informational fields such as those included in the standardized National Incident Fire Reporting Systems' report as well as information normally recorded in police reports can be included in the digital report. It should be noted, however, that the type and amount of information that is collected can be customized by the user of the invention. Therefore, when the responder arrives at the accident scene and after providing essential services, the first responder can collect and enter information using interface 12 or 14 to collect the information.

The invention also automates the collection of data by allowing the first responder to input the data while on the scene by means of manual input or automatic input. By way of an illustrative example only, a first responder my scan a bar code included on any identification, registration or insurance information so that the information is automatically put into the incident report. If, however, a bar code is unavailable, the remote device 16 may capture an image of the identification, registration or insurance information so that it may be input at a later point in time or so that optical character recognition software may be used to input the information.

The invention also allows cross-departmental indexing and efficiencies. By way of an illustrative example only, if the first responder to reach the scene of a car accident is a firefighter, the fire fighter may use the remote device to collect the above incident information, leaving simply the determination of driver fault and/or liability to be completed by the police officer. Once liability/fault has been determined the remote device may be used to create an incident report that may be used by both the police and fire departments.

Once the report information or data is collected, the remote computer readable instructions can transmit the report information to a central location having a server 16 with a server computer readable medium having server computer readable instructions in electronic communications with the remote computer device. The electronic communications between the server and remote device can be real-time, batch, wired or wireless. The server computer readable instructions can use the received data and format a report based upon the requirements for the particular jurisdiction. The format requirements can either be stored in the server or obtained by the server by communicating with a database containing the relevant formatting information. This report can be electronically generated and transmitted or can be printed or otherwise converted into a physical format for transmission or storage.

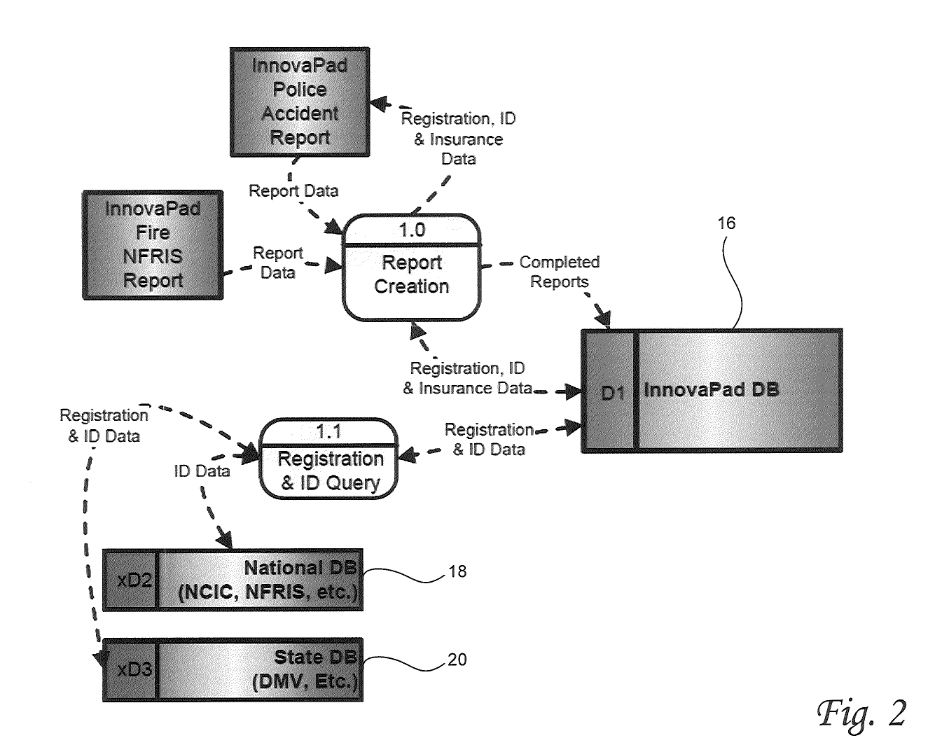

In one embodiment, shown in FIG. 2, the server is in communications with a national database 18 and state database 20. When the server receives identification information from the remote device, the server can query database 18 or 20 and retrieve any information associated with the identification information. For example, if the first responder gathers the driver's license number from the accident scene, the driver's license number can be used to retrieve associated information. Additionally, the first responder may gather insurance information, this information can be used to retrieve any other information, including but not limited to associated identification and/or policy information associated with the insurance information. This information can be used to create the needed report. Once the report is created, it can be stored on the server. Further, the information, through this invention, for reports used by any type of first responder can be indexed with each other so that comprehensive information concerning an accident involving multiple departments, such as police and fire and EMS, can be collected without the traditional problem associated with attempting to cross-reference police, fire, EMS, etc. reports and information.

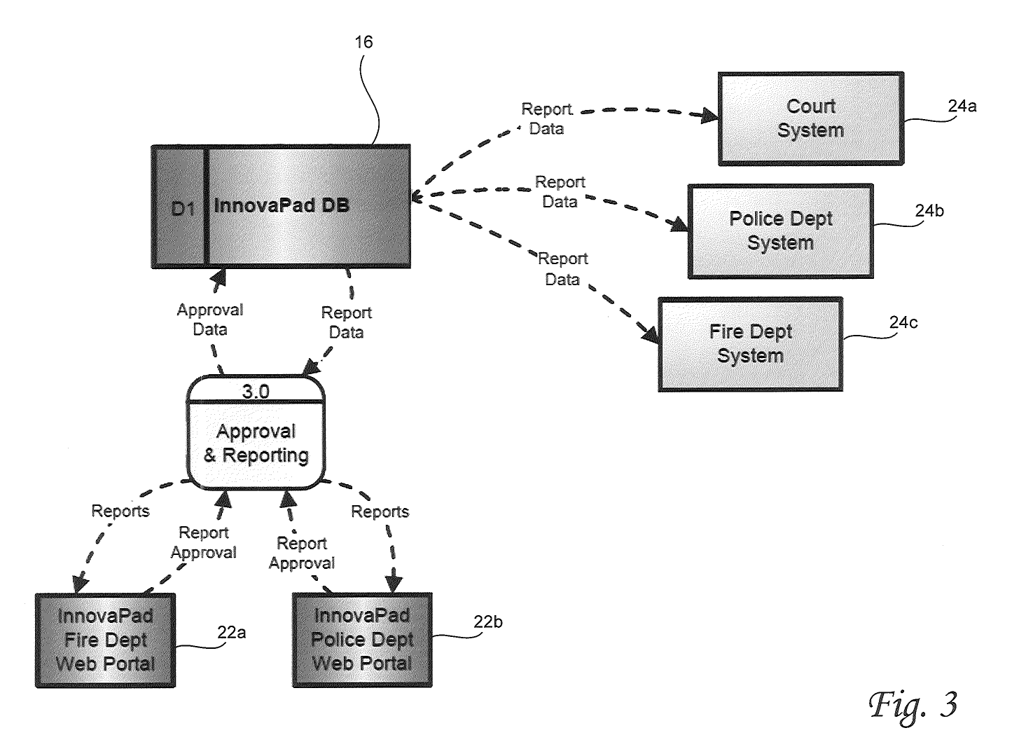

As can be seen in FIG. 3, in one embodiment, the approvals of reports for and incident is provided by the current invention. In this embodiment, a responder interface is available for first responders such as police, fire, EMS and the like. A SaaS or ASP architecture can be used to provide this functionality allowing the responders to access the server for various functions. For example, when an incident report (whether police, fire or EMS) is generated, the report needs to be approved in many municipalities prior to it being issued as a formal “original” report. When reports are created by physically marking physical forms corrections can be time consuming and unnecessarily repetitive as the physical form has to be corrected. Therefore, this invention provides an electronic approval process for transitioning draft report into final or official reports. The report information is formatted into a draft report which is stored on the server. The first responder can retrieve the report using an interface such as 22a for fire or 22b for police. The reports can be retrieved by any number of methods such as date, location, individual responder, individuals involved with the accident, estimated damage amount, time, date and information that is gathered by the first responder.

When the form is retrieved, the first responder and/or supervisor for the first responder is presented with a draft report. The first responder and/or supervisor verifies the information on the report, format, completeness and other criteria and can either (a) request that the reporting first responder provide additional information or modify information on the report or (b) approve the report. In one embodiment, once the report is finalized, the report may no longer be edited. In one embodiment, the report is digitally signed so that any changes (authorized or not) to the report can be detected. In one embodiment, versions of the report are stored along with the finalized report. Once the report is finalized, it can be stored on the server.

In one embodiment, the server can be in electronic communications with third party systems, including but not limited to a court system 24a, police department system 24b and fire department system 24c. In this embodiment, the finalized report can be automatically transmitted to each of these third parties or selectively to the appropriate third party. In one embodiment, the third party can access the server through an interface such as webpage and the like and retrieve the desired final report. In one embodiment, various individuals and organizations can be provided access to the server with limited access to particular reports such as attorneys, medical providers and those with specific needs. Further, the final reports can be transmitted to such third parties as to the National Fire Incident Reporting System.

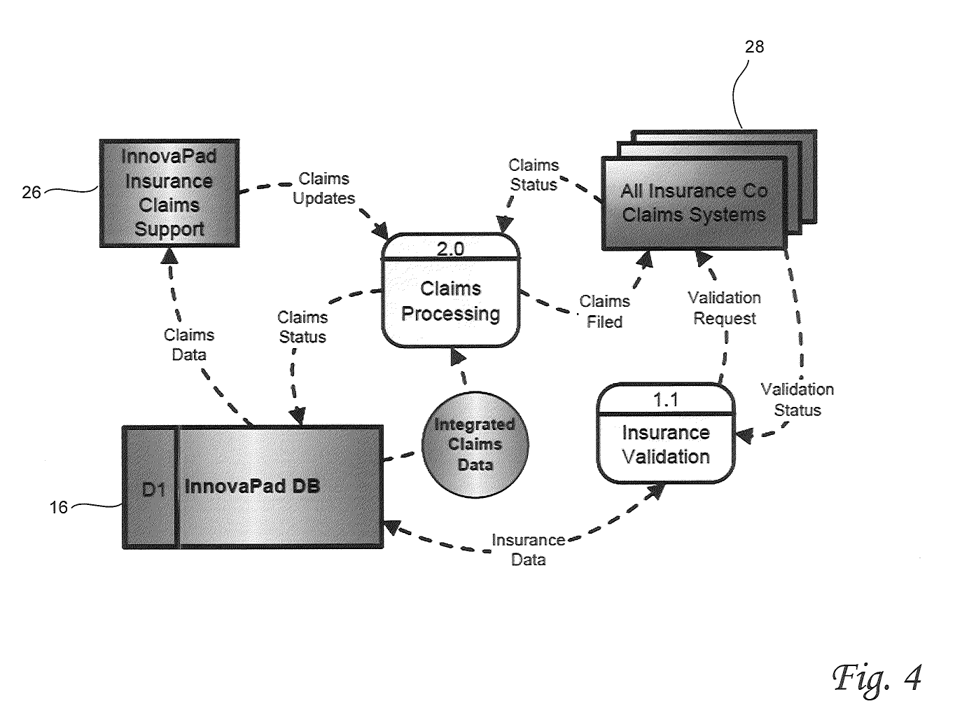

Referring to FIG. 4, additional benefits and functionality of the present invention is shown. The server and its server computer readable instructions 16 can use the report information and even the information received from third party databases such as 18 and 20, and generate an insurance claim 26. Once the appropriate insurance information is collected and input into the digital report, the remote device 16 may then verify the insurance information with the insurance company's claim system and/or database 28. Once the information is verified, this insurance claim can be transmitted to the appropriate insurance company 28 for processing and adjusting. The insurance claim can be transmitted to the appropriate insurance company with the invoice generated using information from the incident itself and from the changes from the reporting and/or supervising first responders that can be retrieved from the responders' information systems. For example, the fire department may issue a schedule of charges for specific services that can be either provided to the server or retrieved by the server.

The claim information can be then be transmitted from the insurance company to the server and include information such as status, claim number, adjuster and the like. In one embodiment, authorized parties such as the first responder and/or individual being charged can access the server to view the status of the claim. In one embodiment, the individual being charged can transmit an existing invoice transmitted to the server and the bill can be associated with the accident information to generate a claim for processing.

In one embodiment, the server can use identification information, such as driver's license number, name, address, phone number and the like to retrieve insurance information about an individual. This information can be retrieved in response to incident information and then transmitted to the responder so that the responder can use the information to verify the insurance information while still on the accident scene.

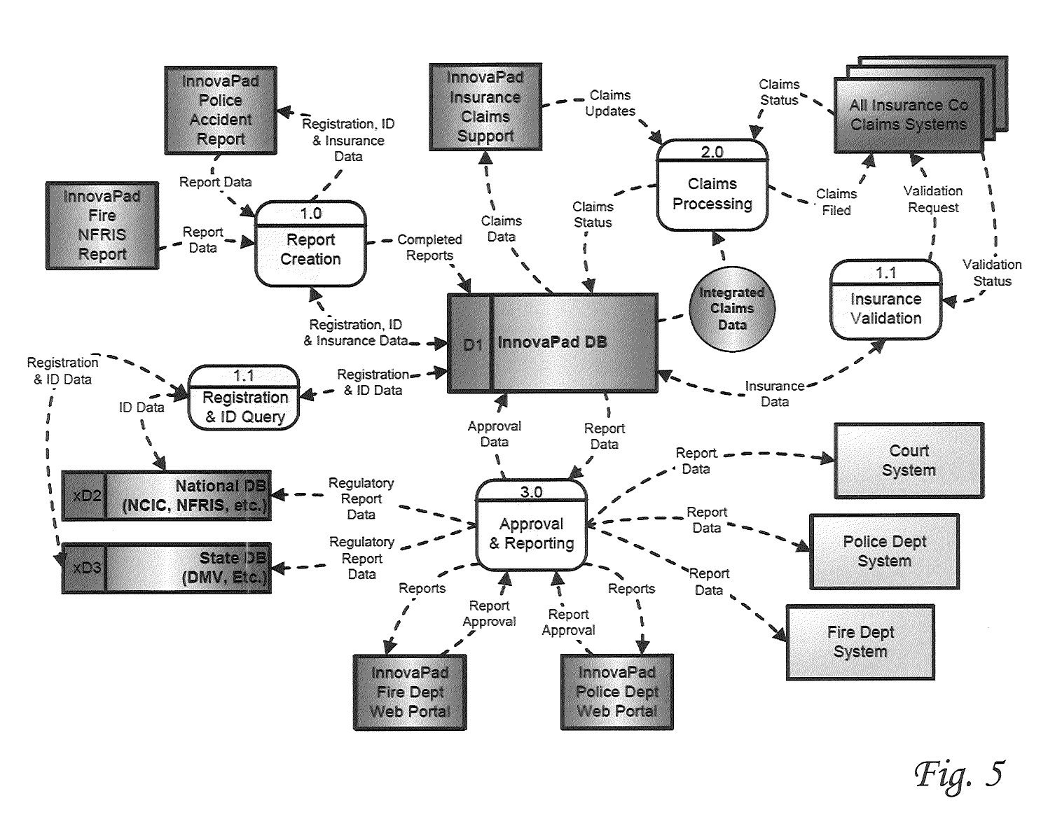

FIG. 5 illustrates one embodiment of the relationships and data flow between the various entities that benefit from the present invention. Another feature to the present invention is the centralization of the information that typically has been separated and unlinked among several entities. The present invention includes the ability through computer readable instructions to provide reporting data that includes the collected and generated data of the present invention as shown in FIG. 5 and Forms 1 and 2.

In operation, the information from the various sources needs to be indexed and associated for subsequent retrieval. In one embodiment, the portable computing device 16 includes a GPS receiver, internal clock and cellular receiver. From the GPS receiver the location of the portable computing device can be associated with the information collected so that the information collected will include the physical location and date and time. This can exist for information collected by first responder for use in the incident report as well as the NFRIS report. With the location, date and time, the information from the police report and the fire report can be associated when the location, date and time match. In one embodiment, the computer readable code links the two datasets and transmits indicates that the link needs to be verified by an individual. In one embodiment, the computer readable instructions generate a notification under certain exceptions such as: two or more fire reports have the same location, date and time; two or more police reports having the same location, date and time; only one police report without a fire report, only one fire reports without a police report. Additionally, a dispatch call number, representing the dispatch of the fire or police which can be associated with a location. The location information from the fire and police can be used to associated the dispatch call numbers thereby linking the information associated with the report resulting from the dispatch of the police or fire.

In another embodiment, the dispatch of the fire and police dispatch as associated with an incident number which is used to identify the police information or the fire information. The incident number can be used for indexing the information gathered from the police and fire responders. In this embodiment, the fire and police dispatch systems are linked and each department is provided a unique number which is shred when both fire and police are dispatched.

In one embodiment, each incident is given a unique number generated by the central server and this number is assigned to the incident where the police or fire is dispatched. The police or fire responder is asked to provide data associated with the incident so that the information collected is tied to an internally generated incident number.

In one embodiment, a hierarchy of data points are used to link the information collected together. In one example, the system determines whether there is an incident number that can be associated with the incident information for both fire and police. If this number is not available, the system attempts to use location information, date and time to provide a unique identifier for each incident and associate the gather information by this unique identifier. The invention can also use the address of the incident to link the gathered data that is provided by dispatch or as recorded by the responder recording the information to link the data.

The actual scope of the invention encompasses not only the disclosed embodiments above, but also all equivalent ways of practicing or implementing the invention. The above detailed description of the embodiments of the invention is not intended to be exhaustive or to limit the invention to the precise form disclosed above or to the particular field of usage mentioned in this disclosure. For example, the examples as to the types of first responders and the types of incidents is not meant to be exhaustive of the types of first responders who may use the invention or the types of incidents for which the invention may be used. Moreover, the types of information collected is not meant to be exhaustive and will change depending on the type of user of the invention.

What is claimed is:

1. A system for automating and integrating accident reporting and cost recovery comprising:
a server having a computer readable medium and a processor, the server in electronic communications with a remote computing device and one of a national fire database, a state accident database, an insurance company, and a fire department; and,
a set of computer readable instructions stored in the computer readable medium that, when executed by the processor, are configured to:
receive accident data from the remote computing device;
generate an insurance claim;
generate at least one accident report according to a predetermined format;
receive accident report approval information;
finalize the accident report; and
transmit the accident report to at least one member of a group comprising a national fire reporting system, a state accident reporting system, a first responding system, and an insurance system.

2. The system of claim 1, further including a set of remote computer readable instructions stored in the remote computing device that, when executed by a processor integrated with the remote computer device, performs the steps of: receiving accident information input by a user, receiving insurance information from the server, providing the insurance information to the user of the remote computing device, providing the user with a draft report for display prior to the user transmitting the report to a supervisor for review and finalization.

3. The system of claim 2 wherein the accident information includes information taken from the group consisting of: physical location information, date, time, GPS information, vehicle information, structure information, property damage information, injury information, insurance information, personally indentifying information, audio information, video information, image information, responder information, text and graphical information.

4. The system of claim 1 including server computer readable instructions of verification that the report complied with regulatory requirements.

5. The system of claim 1 including a user interface providing access to the server for allowing selected user limited access to the reporting data.

6. The system of claim 1, wherein the set of computer readable instructions stored in the computer readable medium, when executed by the processor, are further configured to:
receive insurance claim status information and provide the insurance claim status information to the first responder(s) involved with the accident.

7. The system of claim 1, wherein the set of computer readable instructions stored in the computer readable medium, when executed by the processor, are further configured to transmit the insurance claim to an insurance company.
